(19) United States
(12) Patent Application Publication
(10) Pub. No.: US 2007/0259631 A1
(43) Pub. Date: Nov. 8, 2007

(54) Radio Transmitter and a Method of Operating a Radio Transmitter

(75) Inventors: Kenneth Ljung, Stockholm (SE); Staffan Nystrom, Haninge (SE); Thomas Lejon, Vallentuna (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: ANDREW CORPORATION, Orlando Park, IL (US)

(21) Appl. No.: 11/571,661

(22) PCT Filed: Jun. 21, 2005
(86) PCT No.: PCT/SE05/00966

§ 371 Date: Jul. 26, 2007

Related U.S. Application Data
(60) Provisional application No. 60/521,825, filed on Jul. 8, 2004.

(30) Foreign Application Priority Data
Jul. 8, 2004 (SE) 0401797-6

(51) Int. Cl. H01Q 11/12; H04B 1/04

(52) U.S. Cl. 455/127.2

(57) ABSTRACT

By the present invention is provided an inventive radio transmitter and a method to operate a radio transmitter, by which the quality of a transmitted radio signal can be improved. The radio transmitter comprises at least one digital filter having adjustable parameters. Via a control signal input the transmitter can receive a feedback signal being indicative of the output signal from the transmitter. The radio transmitter comprises programmable digital circuitry adapted to analyzing the feedback signal and to generating an analysis result. The programmable digital circuitry is further adapted to adjusting the adjustable parameters of the digital filter in accordance with the analysis result.

### FIELD OF THE INVENTION

The present invention relates to the field of radio communications in general, and to radio transmitters in particular.

### BACKGROUND

Mobile radio communications have become increasingly popular over the last decade, and many mobile radio networks provide data communication services as well as voice services. In both voice and data communication services, the quality of the radio transmission is of utmost importance. If the quality of the transmitted radio signal is poor, the receiver of the data/voice signal may have difficulties perceiving the contents of the signal. Furthermore, poor quality of the transmitted radio signal may cause the need for re-transmission of data. Such re-transmission of data is both time and bandwidth consuming.

### SUMMARY

A problem to which the present invention relates is the problem of how to improve the quality of the radio signals transmitted by a radio transmitter.

This problem is addressed by a radio transmitter for transmitting a radio signal, said radio transmitter comprising
an transmitter input for receiving a digital signal;
a transmitter output coupled to an antenna for outputting a transmitter output signal;
at least one digital filter having at least one adjustable parameter;
a control signal input for receiving a feedback signal indicative of said output signal; and
programmable digital circuitry adapted to analyzing said feedback signal and to generating an analysis result, wherein said programmable digital circuitry is further adapted to adjusting said parameters in accordance with the analysis result.

The problem is further addressed by a method of operating a radio transmitter, the method comprising
receiving a digital signal to be transmitted by the radio transmitter;
processing said digital signal in at least one digital filter having at least one adjustable parameter;
converting said processed digital signal into an analogue signal;
processing said analogue signal in analogue radio circuitry, thus generating a transmitter output signal;
feeding a signal indicative of the transmitter output signal back to a control part of the radio transmitter as a feedback signal;
analysing said feedback signal in order to identify correctable deviations from a desired signal; and
adjusting at least one parameter of said digital filter so as to minimise identified correctable deviations.

By the inventive radio transmitter and method of operating a radio transmitter is achieved that any non-linearities of analogue digital circuitry of the radio transmitter can automatically be compensated for by adjusting parameters of digital filters of the radio transmitter in accordance with results from analysing a feedback signal being indicative of the transmitter output signal. The characteristics of the transmitter output signal can hence be controlled, and the quality of the transmitted radio signal can be improved. Hence, the need for re-transmission of data over a radio interface, and the need for interrupting a radio transmission due to poor radio quality, can be reduced.

In one aspect of the inventive transmitter, said radio transmitter further comprises a pulse shaping filter, and said programmable digital circuitry is adapted to using a signal indicative of the output signal from said pulse shaping filter as a reference signal in analyzing the feedback signal. In this aspect of the invention, the method of operating a radio transmitter further comprises the step of processing said digital signal in a pulse shaping filter; and the step of analysing comprises comparing said feedback signal to a reference signal, said reference signal being a signal indicative of the output of the pulse shaping filter.

Hereby is achieved that the analysis of the feedback signal can be performed as a comparative analysis of the feedback signal and a reference signal, wherein the reference signal is of the desired shape.

In one embodiment of the invention, the radio transmitter further comprises a pre-distortion filter having adjustable parameters; and said programmable digital circuitry is adapted to adjusting the adjustable parameters of the pre-distortion filter. In this embodiment, the adjusting at least one parameter of the method of operating a radio transmitter comprises updating parameters of said pre-distortion filter.

Hereby is achieved that any non-linearity of the components of analogue radio circuitry of the radio transmitter can be adaptively compensated for, such as e.g. the non-linear power response of a power amplifier. Such compensation can be automatically performed upon operation of the radio transmitter. Hence, any undesired widening of the transmitted signal in the frequency domain can be reduced.

In one aspect of this embodiment, the pre-distortion filter comprises a look-up table having updateable contents; and said programmable digital circuitry is adapted to updating said contents in accordance with said analysis result. Hereby is achieved that the adjusting of the adjustable parameters can be easily be performed by writing new contents in the look-up table. In this aspect, the look up table could advantageously comprise an active part and an inactive part, the updating of the contents being performed on the inactive part, and the inactive and active part swapping activity level upon completed performance of the updating.

In one embodiment of the invention, said at least one digital filter comprises a frequency compensation filter having at least one coefficient; and said programmable digital circuitry is adapted to adjusting said at least one coefficient. a flat frequency response of transmitter in the radio carrier bandwidth can be maintained. Analogue components of the analogue radio circuitry, such as analogue filters, often show characteristics which vary with e.g. temperature or age. Hence, by introducing a frequency compensation filter having adjustable parameters, correction of spectrum tilt caused by imperfections in the analogue radio circuitry 310 can be continuously performed upon operation of the radio transmitter.

In one embodiment of the invention, wherein the analogue radio circuitry of the radio transmitter comprises an analogue gain control device and said at least one digital filter comprises a digital gain control device, the programmable digital circuitry is adapted to analysing the gain of said feedback signal resulting a gain analysis result; and said programmable digital circuitry is further adapted to adjusting the gain of the digital gain control device and the gain of the analogue gain control device in accordance with said gain analysis result. In this embodiment, the inventive method comprises analysing the gain of said feedback signal; and adjusting the gain of the digital gain control device and the gain of the analogue gain control device in accordance with the result of said analysis of the gain.

Hereby is achieved that the signal can be amplified prior to the introduction of at least two major noise sources: the quantisation noise from the digital-to-analogue converter, and thermal noise from an intermediate filter. Hence, the out-of-band requirements on the transmitter output signal can more easily be met.

In one aspect of this embodiment, the analogue radio circuitry comprises an output filter which is a fullband output filter. Hereby is achieved that the same output filter can be applied to output signals of all carrier frequencies, thereby making the design of the radio transmitter simpler.

In one embodiment of the inventive radio transmitter, the radio transmitter further comprises a measurement receiver, having a measurement input coupled to the transmitter output; an analogue to digital converter; and a feedback signal output coupled to said control signal input. Hereby is achieved that the feedback signal can easily be obtained.

In this aspect of the invention, the analogue to digital converter can advantageously be arranged to sample the input signal to the analogue to digital converter at four times the carrier frequency of the input signal to the analogue to digital converter, and the measurement receiver can advantageously comprise a demultiplexer for demultiplexing the sampled signal into one signal representing the imaginary part and another signal representing the real part of the input signal to the analogue to digital converter. In the method of operating the radio transmitter, the step of feeding further comprises, in this aspect, sampling the transmitter output signal or a second signal indicative thereof at a rate of four times the carrier frequency of the sampled signal; and separating the transmitter output signal into an imaginary and a real part by demultiplexing the sampled signal resulting from said sampling. Hereby is achieved that a down conversion to half the data rate can be obtained at the same time as the of the imaginary and real components of the sampled signal are separated. The complexity, size and cost of the measurement receiver can hence be reduced.

The problem to which the present invention relates is further addressed by a computer program product comprising computer program code means operable to, when executed on programmable digital circuitry:
receive a feedback signal;
receive a reference signal;
perform a comparative analysis of said feedback signal and said reference signal in order to identify correctable deviations of said feedback signal from said reference signal signal; and
generate a control signal in response to said comparative analysis.

The inventive radio transmitter can advantageously be applied to all areas of radio communication where the quality of the transmitted radio signal is of importance, such as in mobile radio communications. The inventive radio transmitter can hence advantageously be part of a radio base station, or a mobile station, operating within a mobile radio network.

### BRIEF DESCRIPTION OF THE DRAWINGS

The present invention will now be discussed in more detail with reference to preferred embodiments of the present invention, given only by way of example, and illustrated in the accompanying drawings, in which:

FIG. 1 is a schematic illustration of an example of a mobile radio communication system.

FIG. 2 is a schematic illustration of an example of an inventive radio base station.

FIG. 3 is a schematic illustration of an example of an inventive radio transmitter.

FIG. 4 is a schematic illustration of programmable digital circuitry used in an embodiment of the inventive transmitter.

FIG. 5 is a schematic illustration of a pre-distortion filter used in an embodiment of the inventive transmitter.

FIG. 6 is a schematic illustration of a frequency compensation filter used in an embodiment of the inventive transmitter.

FIG. 6a is a logical illustration of a frequency compensation filter used in an embodiment of the inventive transmitter.

FIG. 6b is an illustration of the frequency compensation filter logically illustrated in FIG. 6a.

FIG. 7 is a schematic illustration of analogue radio circuitry of a radio transmitter.

FIG. 8 is a schematic illustration of a measurement receiver used in an embodiment of the invention.

FIG. 9 is an illustration of an I/Q-separation unit and a down converter used in an embodiment of the inventive measurement receiver.

FIG. 10 is a flowchart schematically illustrating the inventive method.

FIG. 11a is a flowchart schematically illustrating the inventive method according to one embodiment.

FIG. 11b is a flowchart schematically illustrating the inventive method according to another embodiment.

### DETAILED DESCRIPTION

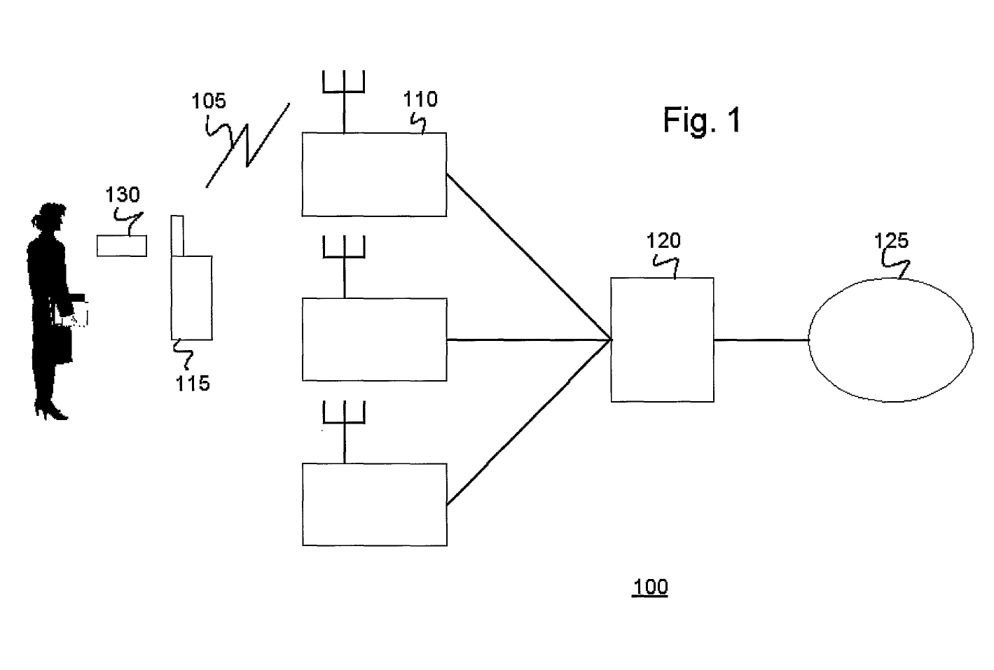

FIG. 1 schematically illustrates the architecture of a mobile radio network 100. Mobile radio network 100 provides radio communication to users of mobile stations over a radio interface 105 via radio base stations 110. A mobile station 115 capable of communicating within mobile radio network 100 is shown in FIG. 1. Radio base stations 110 are connected to a radio network controller 120, which in turn is connected to a core network 125. A mobile radio network 100 normally comprises a plurality of radio network controllers 120, each connected to a plurality of radio base stations 110. Mobile radio network 100 could operate according to any standard for mobile radio telephony such as the Wideband Code Division Multiple Access (WCDMA), the Global System for Mobile Communications (GSM), or D-AMPS (specified in e.g. EIA/TIA-IS-54 and IS-136).

In many implementations of mobile radio network 100, mobile radio network 100 provides voice services as well as data transmission services to the users of mobile stations 115. User data 130, illustrated in FIG. 1 as being transmitted between mobile station 115 and a user of mobile station 115, could hence relate either to a voice service or a data service. In order to effectively utilize the limited bandwidth of radio interface 105 and to minimise the need for re-transmission of data, the quality of the signals transmitted from the radio base station 110 and the mobile stations 115 across the radio interface 105 is of utmost importance. The minimisation of the need for re-transmission is of particular importance for the real-time services provided by mobile radio network 100.

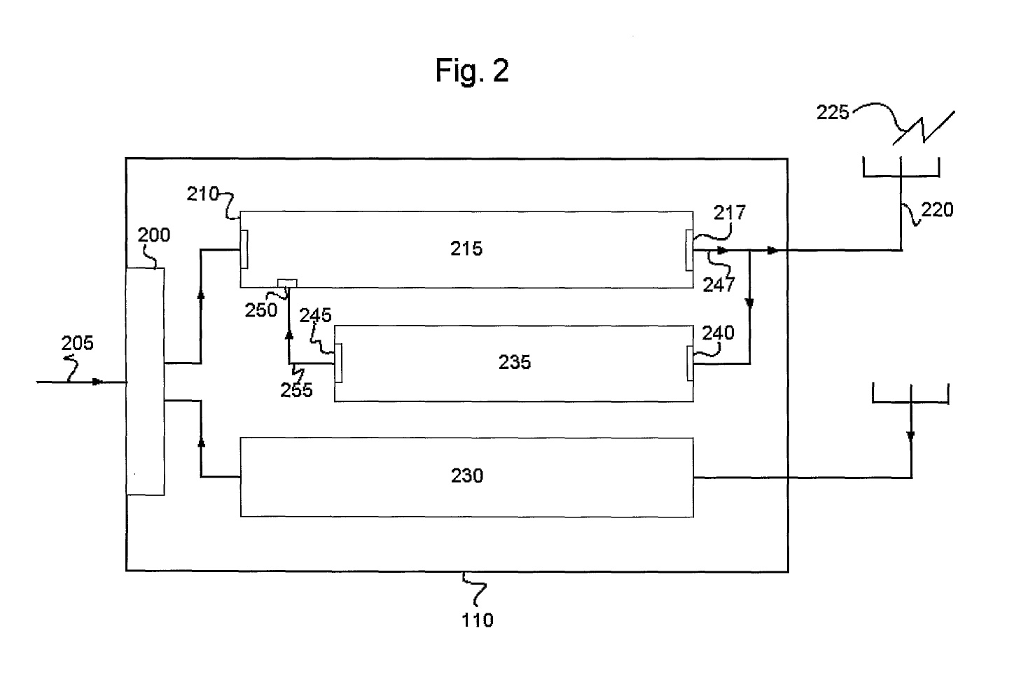

FIG. 2 illustrates an example of a radio base station 110 according to the invention. The radio base station of FIG. 2 comprises an interface 200 for receiving data signals 205 from the radio network controller 115. The data signals 205 comprises user data 130 to be transmitted to a mobile station 115. Interface 200 is connected to an input 210 of a transmitter 215, which in turn is connected via an output 217 to an antenna 220 for transmitting radio signals 225 across the radio interface 105. Interface 200 of radio base station 110 is preferably further connected to a receiver 230 for receiving a signal from a mobile station 115 via the radio interface 105. Transmitter 215 comprises functionality for processing the data signal to be transmitted so as to provide a signal suitable for transmission over the radio interface 105.

According to the invention, radio base station 110 further comprises a measurement receiver 235, having an input 240 and an output 245, for receiving a signal indicative of the transmitted radio signal 225. The measurement receiver 235 can be used in order to provide the transmitter 215 with information about the characteristics of the transmitted signal, and supervision of the transmitted signal can thus be facilitated. The information about the characteristics of the transmitted signal can e.g. be used by the transmitter 215 in the supervision of the frequency response of the gain of transmitter 215, and to support adaptive pre-distortion.

The input 240 of measurement receiver 235 is preferably connected to the output 217 of transmitter 215, so that measurement receiver 235 can receive a fraction of any signal fed by transmitter 215 to the antenna 220. The signal fed by transmitter 215 to the antenna 220 will hereinafter be referred to as the transmitter output signal 247. The output 245 of measurement receiver 235 could preferably be connected to a control signal input 250 of transmitter 215, so as to provide transmitter 215 with a feedback signal 255 relating to the transmitter output signal 247. Needless to say, input 240 and control signal input 250 of transmitter 215 can be co-located.

The feedback signal 255 can be used in order to optimise transmission parameters of transmitter 215. Properties of analogue components of transmitter 215 often vary over time, as a result of e.g. changes in ambient temperature or ageing. By analysing the feedback signal 255, adjustable parameters of transmitter 215 may be adjusted so as to compensate for variations in the properties of the analogue components of transmitter 215. Hence, it may be secured that the transmitter output signal 247 from transmitter 215 coincides with the desired transmitter output signal, regardless of any drift in the analogue components of transmitter 235. Furthermore, in order to keep production costs low, it may be desirable to use analogue components with low accuracy when constructing transmitter 215, resulting in different properties of the analogue components of different transmitters 235. Hence, analysis of the feedback signal 255 can be used to calibrate transmitter 215 by adjusting adjustable parameters of transmitter 215. By doing so, it can be guaranteed that a transmitter 215 fulfils particular requirements.

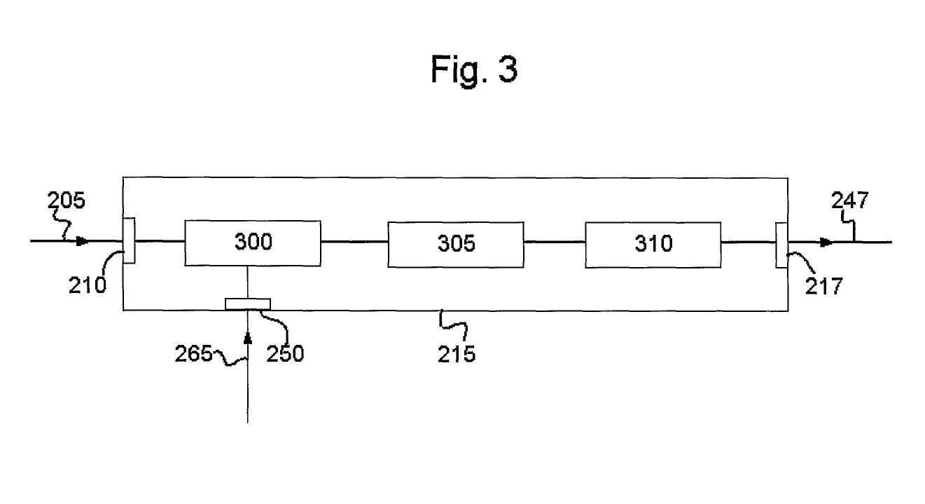

FIG. 3 schematically illustrates an embodiment of transmitter 215 according to the invention. Transmitter 215 of FIG. 3 comprises programmable digital circuitry 300, a digital-to-analogue converter (DAC) 305 and analogue radio circuitry 310 connected in series. Programmable digital circuitry 300 provides digital signal processing of the data signal 205 received from the radio network controller 115. DAC 305 provides conversion of the digital signal from the programmable digital circuitry 300 into an analogue signal, and analogue radio circuitry 310 is arranged to generate the transmitter output signal 247 to be fed to antenna 215. Programmable digital circuitry 300 comprises software for analysing the feedback signal 255 received from the measurement receiver 235 and at least one digital filter for filtering the signal to be transmitted. According to the invention, at least one of the digital filters in programmable digital circuitry 300 has adjustable parameters.

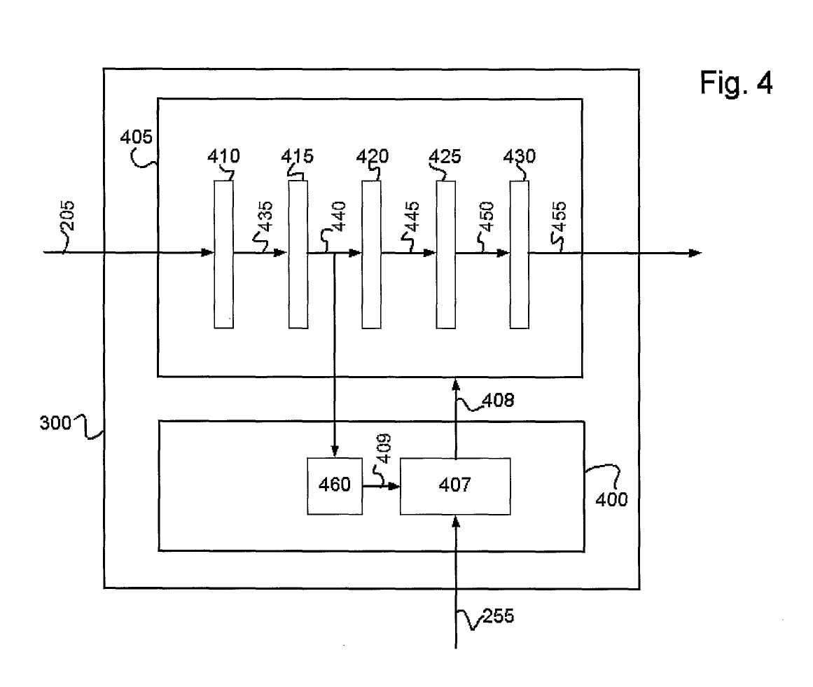

FIG. 4 illustrates an example of the programmable digital circuitry 300. For purposes of illustration, the programmable digital circuitry 300 of FIG. 4 comprises a digital signal processor (DSP) 400 and a Field Programmable Gate Array (FPGA) 405. Obviously, programmable digital circuitry 300 could comprise any combination of hardware that can provide programmable digital signal processing. For example, the FPGA 405 could be replaced by an ASIC, or programmable digital circuitry could be implemented as a DSP only, or as an FPGA only. Furthermore, hardware components used in digital programmable circuitry 300, such as e.g. DSP 400 and FPGA 405 of FIG. 4, can obviously be used by other functionalities in radio base station 110 as well as by transmitter 215. For example, DSP 400 could be further used to control the receiver 240, and FPGA 405 could be further used for implementing the receiver 230 and the measurement receiver 235, and as an internal data bus for communication between different parts of radio base station 110.

The FPGA 405 of FIG. 4 has been configured to comprise a pulse shaping filter 410, such as a Root Raised Cosine (RRC) filter, a first up-sampling filter 415, a pre-distortion filter 420, a second up-sampling filter 425 and a Frequency Correction Filter (FCF) 430. Programmable digital circuitry 300 preferably comprises two sets of digital filters: one set for the real part of the signal and one set for the imaginary part of the signal. However, in order to simplify the description, only one set of filters is shown in FIG. 4.

A data signal 205 received at the input 210 of transmitter 215 is first fed to the pulse shaping filter 410, in which the signal is shaped according to the requirements of the relevant application. In a base station operating according to the WCDMA standard, e.g., the pulse shaping filter 410 would advantageously be an RRC filter. The pulse shaped signal 435 is then fed to the first up-sampling filter 415, in which the data rate is increased. This increase in data rate is mainly performed in order to facilitate for pre-distortion of the signal. Obviously, the first up-sampling filter 415 could, in whole or in part, be connected to the input side of the pulse shaping filter 410, so that at least parts of the increase of the data rate is performed before the pulse shaping in the pulse shaping filter 410. The first up-sampled signal 440 is then fed to the pre-distortion filter 420.

Pre-distortion filter 420 is mainly for compensating for any non-linearity of the components of analogue radio circuitry 310, such as e.g. the non-linear power response of a power amplifier. The non-linear response of the analogue radio circuitry 310 gives rise to an undesired widening of the signal spectrum (in a WCDMA application, the 5 Mhz wide pulse shaped signal 425 could typically be distorted into a 15 Mhz wide signal). The increased data rate of the first up-sampled signal 440 facilitates for the pre-distortion filter 420 to generate a compensation signal of similar width to the distorted signal caused by the analogue radio circuitry 310. The compensation signal is added to the first up-sampled signal 440, resulting in a pre-distorted signal 445. The pre-distorted signal 445 is then fed to a second up-sampling filter 425, in which the data rate is further increased. In one embodiment of the invention, the data rate is increased 8 times by the first up-sampling filter 415, and two times by the second up-sampling filter 425, although any desired increase in the data rate may be used. Needless to say, the amount of up-sampling in the first and second up-sampling filters 415 and 425 can be chosen according to the requirements of the application of transmitter 215. In some applications, more, or less, up-sampling filters than the two shown in FIG. 4 may be required.

From the second up-sampling filter 425, the second up-sampled signal 450 is fed to the frequency compensation filter 430. Frequency compensation filter 430 is mainly for maintaining a flat frequency response of transmitter 215 in the radio carrier bandwidth. Analogue components of the analogue radio circuitry 310, such as analogue filters, often show characteristics which vary with e.g. temperature or age. Hence, in frequency compensation filter 430, correction of spectrum tilt caused by imperfections in the analogue radio circuitry 310 is performed. Furthermore, frequency compensation filter 430 can advantageously be used in signal gain control, in conjunction with analogue gain control in analogue radio circuitry 310.

The frequency compensated signal 455 is fed to the DAC 305 and further on to the analogue radio circuitry 310 and the antenna 220.

In programmable digital circuitry 300 of FIG. 4, the DSP 400 comprises software 407 for analysing the feedback signal 255 and for generating a control signal 408 indicating any required adjustment of the parameters of the digital filters of programmable digital circuitry 400. In a preferred embodiment of the invention, a reference signal 409 is used in the analysis of the feedback signal 255 from measurement receiver 235 performed by software 407, in order to facilitate for the detection of any distortion that has occurred in the analogue radio circuitry 310. The reference signal 409 should preferably be of the desired shape of the transmitter output signal 247. Either the pulse shaped signal 435 or the first up-sampled signal 440 could advantageously be used as the reference signal 409, although any if the signals 435, 440, 445, 450 or 455 could be used. In the embodiment shown in FIG. 4, the first up-sampled signal 440 is used as the reference signal 409. A delay mechanism 460 should preferably be used, so that the feedback signal 255 can be analysed in relation to a reference signal 409 representing the same data as feedback signal 255. The time delay in the components of digital circuitry 300, DAC 305 and analogue radio circuitry 310 is normally known, so that the desired time delay of delay mechanism 460 can easily be obtained. Delay mechanism 460 could e.g. be a shift register, or any other mechanism which could introduce a fixed time delay.

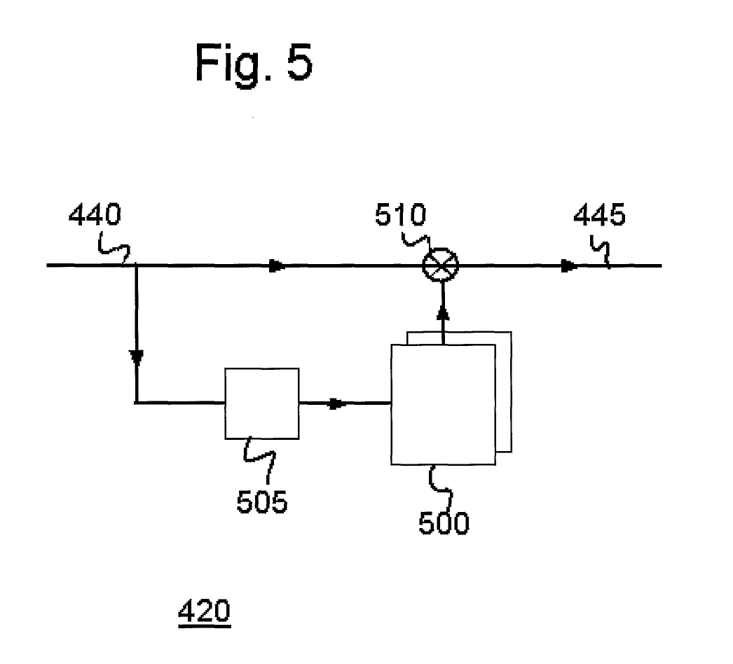

An embodiment of the pre-distortion filter 420 is schematically illustrated in FIG. 5. Pre-distortion filter 420 can advantageously comprise a look up table 500, a magnitude gauge 505 and a multiplier 510. The look up table 500 advantageously comprises a number of entries, each entry comprising a complex scaling factor and each entry being indexed by the square of the magnitude of the signal 440 input to pre-distortion filer 420. Each entry in look up table 500 preferably comprises two values: one value corresponding to the real part of the complex scaling factor, the other corresponding to the imaginary part. The magnitude x of the signal 420 input to the pre-distortion filter 420 is measured in magnitude gauge 505, and the square of the magnitude x, |x²|, could advantageously be used to identify which of the entries in look up table 500 should be used by multiplier 510 for multiplication with the signal 420 input to pre-distortion filter 420. The identified complex scaling factor is then selected and fed to multiplier 510. Multiplier 510 multiplies the signal 420 input to the pre-distortion filter 420 with the selected complex scaling factor. The output from multiplier 510 is the output signal 445 of pre-distortion filter 420. Obviously, any quantity representative of the magnitude of the signal 420 may be used for indexing the values in look up table 500. Furthermore, a similar filter 420 comprising a look up table 500 may be used for the correction of other non-linear responses of the transmitter 215.

In a preferred embodiment of the invention, the contents of the look up table 500 can be updated. Updating of the look up table 500 could e.g. be performed if analysis of the feedback signal 255, fed from measurement receiver 235 to programmable digital circuitry 300, indicates that the contents of look up table 500 does not yield a desired transmitter output signal 247. Such analysis could preferably comprise a comparative analysis of the magnitude of the feedback signal 255 and that of the reference signal 409. Up-dating of the look up table 500 could e.g. be performed upon system initialization, since the properties of different analogue radio circuitries 235 are not necessarily the same, and adjustment of the look up table 500 to a particular analogue radio circuitry 235 would be appropriate. Furthermore, the contents of look up table 500 can become obsolete due to e.g. ageing or temperature dependencies of the components of the analogue radio circuitry 310, and the possibility of updating of the look up table 500 during operation of transmitter 215 solves this problem.

In order to efficiently accomplish updating of the look up table 500 while the transmitter 215 is in operation, look up table 500 may advantageously have an active part and an inactive part: the active part of look up table 500 being in active use, while the inactive part of the look up table 500 is being updated or waiting to be updated. The active and inactive parts of look up table 500 may advantageously be implemented as two separate look up tables 500. A pointer pointing to the active part of look up table 500 could be used in order to distinguish the active part from the inactive part of look up table 500.

In the embodiment of the invention illustrated in FIG. 4, in which the transmitter 225 comprises a DSP 400 and an FPGA 405, the analysis of the feedback signal 255 is preferably performed by the DSP 400. Hence, software 407 of DSP 400 preferably comprises program code for comparing the feedback signal 255 with the reference signal 409, in order to detect any undesired widening of the transmitter output signal 247, and program code for updating the look up table 500 via control signal 408. Software 407 advantageously further comprises program code for controlling, via control signal 408, which part of look up table 500 of pre-distortion filter 420 should be used in the current operation of transmitter 215. Software 407 could advantageously write, in a register in FPGA 405, which part of look up table 500 should be active.

Other implementations of pre-distortion filter 420 may alternatively be used. For example, rather than pre-distortion filter 420 having a look-up table 500, pre-distortion filter 420 could comprise logical circuits for calculating the required pre-distortion as a function of signal magnitude via a polynomial. Depending on the result of the analysis of the feedback signal 255, the coefficients of the polynomial may then be adjusted.

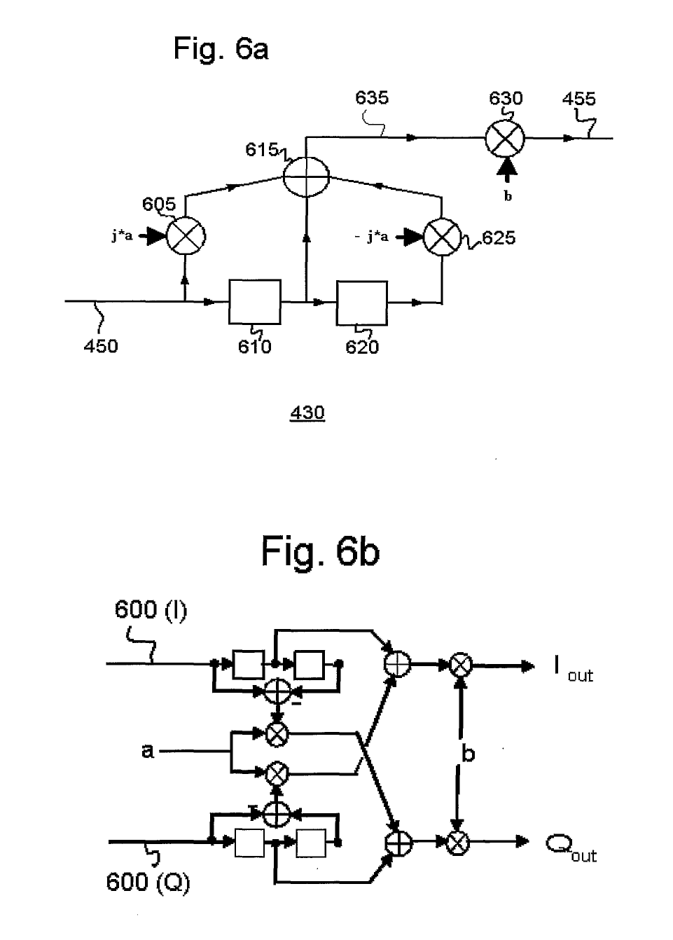

In one embodiment of the invention, the properties of a frequency compensation filter 430 of FIG. 4 can be adjusted according to the indications of the feedback signal 255. The frequency compensation filter 430 could e.g. be a complex Finite Impulse Response (FIR) filter with three taps, where adjustable coefficients are anti-symmetrical around the centre tap. Having anti-symmetrical coefficients around the centre tap ensures a linear phase response and zero group delay variations over the entire frequency band. However, other configurations of frequency compensation filter 430 may be used. FIG. 6a illustrates the complex signal path of an example of a frequency compensation filter 430, where the coefficients a and b may be adjusted according to the indications of the feedback signal 255. The signal 450 input to frequency compensation filter 430 is fed, in parallel, to a first multiplier 605 and to a delay element 610. Multiplier 605 multiplies the signal with j*a, and feeds the signal to an adder 615. Delay element 610 delays the signal, and feeds parts of the delayed signal to the adder 615 and parts to a second delay element 620. The second delay element 620 feeds the twice delayed signal to a second multiplier 625, where the signal is multiplied by −j*a. The second multiplier 625 then feeds the signal to the adder 615. The adder 615 feeds the resulting signal, signal 635, to a third multiplier 630, which multiplies the signal 635 by the coefficient b. The signal from the third multiplier 630 is the output signal 455 from frequency compensation filter 430. The frequency compensation filter 430 may e.g. be realized for the imaginary and real part of the signal as is shown in FIG. 6b, using four delay elements, two multipliers, two sign inversions and two additions.

In the filter configuration shown in FIG. 6, the coefficient a sets the frequency characteristics of the filter, while the coefficient b is used to enable control of the overall amplitude of the signal. The coefficients a and b may be stored in a random access memory (RAM) in programmable digital circuitry 300. In the embodiment of the invention shown in FIG. 4, the coefficients a and b can advantageously be stored in the FPGA 405. Software 407 of DSP 400 preferably comprises program code for analysing the feedback signal 255 in relation to reference signal 409 in order to detect a need to alter the value of the coefficients a and b. Such analysis advantageously involves a comparative analysis of the frequency characteristics of the feedback signal 255 and that of the reference signal 409. Software 407 preferably further comprises program code for calculating improved values of coefficients a and b and for providing FPGA 405 with new values of coefficients a and b via control signal 408. Hence, if the DSP 400 detects that the frequency characteristics of the feedback signal 255 does not correspond to the frequency characteristics of the reference signal 409, the DSP 400 can provide the FPGA 405 with new values of the coefficients a and b to be stored in the RAM and to be used in the frequency compensation of the signal 450.

In many circumstances, it is advantageous to complement the analogue gain control of analogue radio circuitry 310 with digital gain control. This is e.g. the case when the transmitter 215 is used to transmit signals 247 of different carrier frequencies. In the W-CDMA standard, for example, the requirements on the out-of-band transmission for the highest carrier frequencies imply that, when the highest carrier frequency is used, the allowed amplitude of the signal is very low in the frequency range used for the lowest carrier frequency of transmitter 215. Similarly, when the lowest carrier frequency is used, the allowed amplitude is very low in the frequency range of the highest carrier frequency. Hence, the out-of-band requirements can hardly be met by simply introducing one fullband output filter 720 at the output 217 of transmitter 215 that can be applied for all carrier frequencies. To solve this problem, one output filter 720 for each carrier frequency could be introduced. However, according to the invention, the out-of-band requirements can be met by complementing the analogue gain control of analogue radio circuitry 310 with digital gain control. Such digital gain control can advantageously be achieved by varying the coefficient b of multiplier 630 of frequency compensation filter 430. When the analogue gain control of digital circuitry 300 is combined with digital gain control, the output filter 720 could be a single filter operable on the amplified signal 720, regardless of carrier frequency.

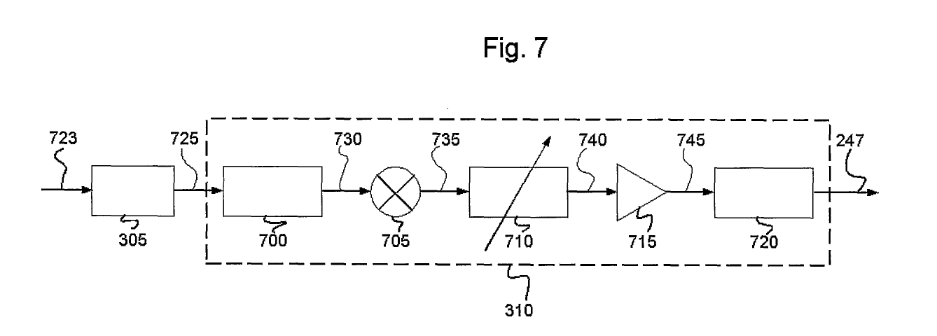

In FIG. 7, analogue radio circuitry 310 of a transmitter 215 is schematically illustrated. Analogue radio circuitry 310 of FIG. 7 comprises an intermediate frequency filter 700 connected to the output of DAC 305, a mixer 705 connected to the output of intermediate frequency filter 700, analogue gain control 710 connected to the output of mixer 705, a power amplifier 715 connected to the output of the analogue gain control 710 and an output filter 720 connected to the output of power amplifier 715. A signal 723, which can advantageously be the frequency compensated signal 455, is fed to the DAC 305 of FIG. 7. The converted signal 725 enters the intermediate filter 705, the filtered signal 730 enters the mixer 705, the mixed signal 735 enters the analogue gain control 710, the output signal 740 from the analogue gain control 710 enters the power amplifier 715, the amplified signal 745 enters the output filter 720, and the transmitter output signal 247 is output from the output filter 720.

In FIG. 2, the input signal to the measurement receiver 235 is shown to be the output signal 247 of the transmitter 215. Depending on what compensation is performed by programmable digital circuitry 300 based on the feedback signal 255, other signals could be used as the input signal to measurement receiver 235. For example, when transmitter 215 comprises an output filter 720, the input signal to the measurement receiver 235 could be the amplified signal 745, if no compensation of drifts in the characteristics of the output filter 720 is required.

Now referring back to FIG. 7, two main contributors to the noise level of the transmitter output signal 247 are the noise originating from the digital-to-analogue conversion of the DAC 305, and the thermal noise of the intermediate filter 700. Thus, in order to reduce the amplitude of the transmitter output signal 247 in the out-of-band frequency band, these two noise contributors should advantageously to be kept to a minimum. In order to achieve this, the present invention suggests to perform a major part of the amplification of the signal-to-be-transmitted prior to the digital-to-analogue conversion, so that the major part of the signal amplification is performed prior to the introduction of the two noise contributors quantisation noise from the DAC 305 and thermal noise from the intermediate filter 700, in order for this noise to never experience the major part of the amplification. Amplification prior to the digital-to-analogue conversion can advantageously be achieved by multiplying the signal 635 (cf. FIG. 6) with an appropriate factor provided by the coefficient b.

Hence, programmable digital circuitry 300 preferably comprises software for analysing the gain of the feedback signal 255, and for adjusting the gain if found necessary. The software for analysing the gain of the feedback signal 255 preferably comprises programme code for comparing the amplitude of the feedback signal 255 with the amplitude of a reference signal 409, in order to obtain the gain of the transmitter 215, and programme code for comparing the gain of the transmitter 215 to a desired gain. The software for adjusting the gain should preferably comprise programme code for determining an appropriate value of the coefficient b of multiplier 630 and for generating a control signal 408 indicative of the determined value of the coefficient b. The software for adjusting the gain preferably further comprises programme code for controlling the analogue gain control 710.

In the embodiment illustrated by FIG. 4, the software for analysing the gain of the feedback signal 255 and for adjusting the gain could advantageously be part of software 407 of DSP 400.

Since the noise level in the out-of-band frequency range can be kept low due to the major part of the amplification taking place prior to the digital-to-analogue conversion, a single fullband filter, which can be used for all carrier frequencies, can advantageously be used as the output filter 720.

In order to minimise the signal-to-noise (S/N) ratio of the multiplier 630, it is desirable to let the multiplier 630 work at the top end of its dynamic range (it is hence advantageous to choose, when designing the transmitter 715, a multiplier 630 that provides the desired amplification at the top end of its dynamic range. Drifts in the gain of the analogue radio circuitry 310, due to e.g. temperature changes or ageing, could then be compensated for by varying the coefficient b of multiplier 630. Adjustments of the gain of analogue radio circuitry 310 in order to compensate for drifts in the gain of the analogue radio circuitry 310 could preferably be performed when the dynamic range of the multiplier 630 has been exceeded.

Analogue gain control 710 of FIG. 7 could e.g. be a step attenuator or a continuous attenuator. When analogue gain control 710 is a step attenuator, the power of transmitter output signal 247 will experience a considerable deviation from the desired output power upon adjustment of the analogue gain control 710, until the digital programmable circuitry 300 has had time to adjust the digital gain control in accordance with the new analogue gain situation. In order to reduce this deviation, an offset could be introduced to the feedback signal 255 in the opposite direction, the introduced offset representing half the gain change expected from the varying of the step attenuator of the analogue gain control 710. This offset could e.g. be introduced by the programmable digital circuitry 300 in the analysis of the gain of the feedback signal 255. Alternatively, the offset could be introduced to the feedback signal 255 in measurement receiver 235. Since step attenuators are often not very precise, i.e. the change in gain resulting from an attenuation increase or decrease by one step often varies between different step attenuator units, and between different steps in the same step attenuator unit. Hence, in order to increase the accuracy in the offset introduced to the feedback signal 255, the gain variation corresponding to each step change in the step attenuator of an analogue gain control 710 could be measured. The result could then be stored in the digital programmable circuitry 300 of transmitter 215 and could be used when selecting an appropriate offset to be introduced to feedback signal 255.

The converted signal 725 (and the filtered signal 730) of FIG. 7, which appears prior to mixer 705, is of the same frequency regardless of which carrier frequency is used for the transmission of transmitter output signal 247. The filtered signal 730, output from the intermediate filter 700, is then mixed by mixer 705 to the desired carrier frequency. Hence, the requirements on the frequency characteristics of the intermediate filter 700 are constant, regardless of which carrier frequency is used.

Obviously, the frequency compensation filter 430 of FIG. 6 is only given by way of example, and other implementations of frequency compensation filter 430, such as a frequency compensation filter of higher order, may be used. Furthermore, the compensation of the frequency characteristics provided by the coefficient a and the gain compensation provided by the coefficient b of frequency compensation filter 430 could be implemented in different units, i.e. frequency compensation filter could be implemented without the multiplier 630, and multiplier 630 could be implemented as a separate digital filter, or as part of another digital filter.

When a measurement receiver 235 is used in conjunction with a transmitter 215, a Root Mean Square (RMS) value of the transmitter output signal 247 can easily be obtained, even when the transmitter output signal 247 is bursty and there are long periods of time when the transmission output power is zero. This scenario, which is referred to in the 3GPP Technical Specification 25.141 V4.5.0, when the transmitter output signal 247 is zero within long periods of time, is difficult to handle with a traditional narrow analogue low pass filter. By performing, in programmable digital circuitry 300, an RMS-calculation on the feedback signal 255 (in the embodiment illustrated in FIG. 4, this calculation could preferably be performed by the DSP 400), or by introducing a digital low pass filter with a mathematical integration of the feedback signal 255, an RMS value can easily be obtained. The RMS-value can then be used in comparison with a calculation of the gain of a reference signal 409 in order to obtain the gain of transmitter 215. When the RMS value is digitally obtained, it is easy to time the reference signal 409 with the feedback signal 255, so that signals representing the same point in time are used to calculate the gain. When analogue RMS-calculations are used, the synchronisation of the reference signal and the signal used for the RMS calculation is often a problem.

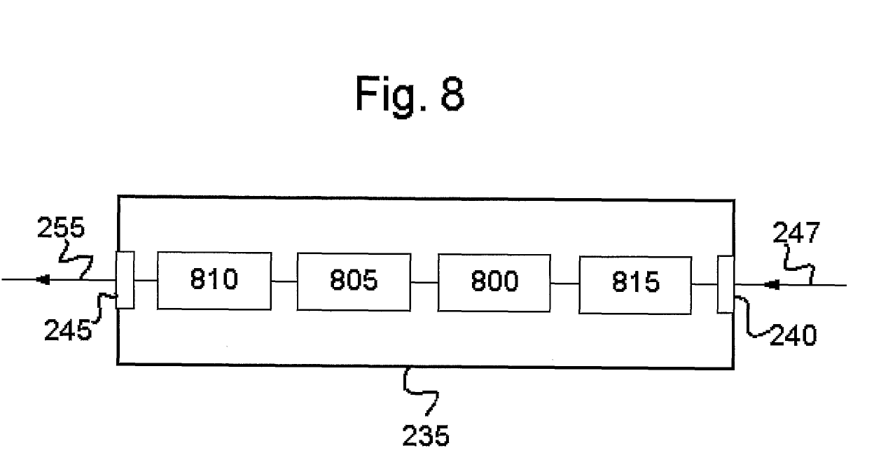

The general architecture of the measurement receiver 235 is schematically illustrated in FIG. 8. The measurement receiver 235 of FIG. 8 comprises an analogue-to-digital converter (ADC) 800 connected to the output 217 of transmitter 215 (cf. FIG. 2), an I/Q-separation unit 805 connected to the output of the ADC 800 and a down converter 810 connected to the outputs of the I/Q-separation unit (denoting the imaginary part of the signal and Q denoting the real part of the signal). The I/Q-separation unit 805 and the down converter 810 can advantageously be implemented on the same physical programmable digital circuitry as the programmable digital circuitry 300 of transmitter 215.

The measurement receiver 235 preferably converts the real-valued signal 247 of carrier frequency f₀ into a digital signal at complex baseband, so that both amplitude information and phase information relating to the transmitter output signal 247 can easily be obtained. Furthermore, the resulting digital feedback signal 255 should preferably be of the same data rate as the reference signal 409. The required down conversion in measurement receiver 235 is hence dependent on the up-conversion made in the transmitter 215.

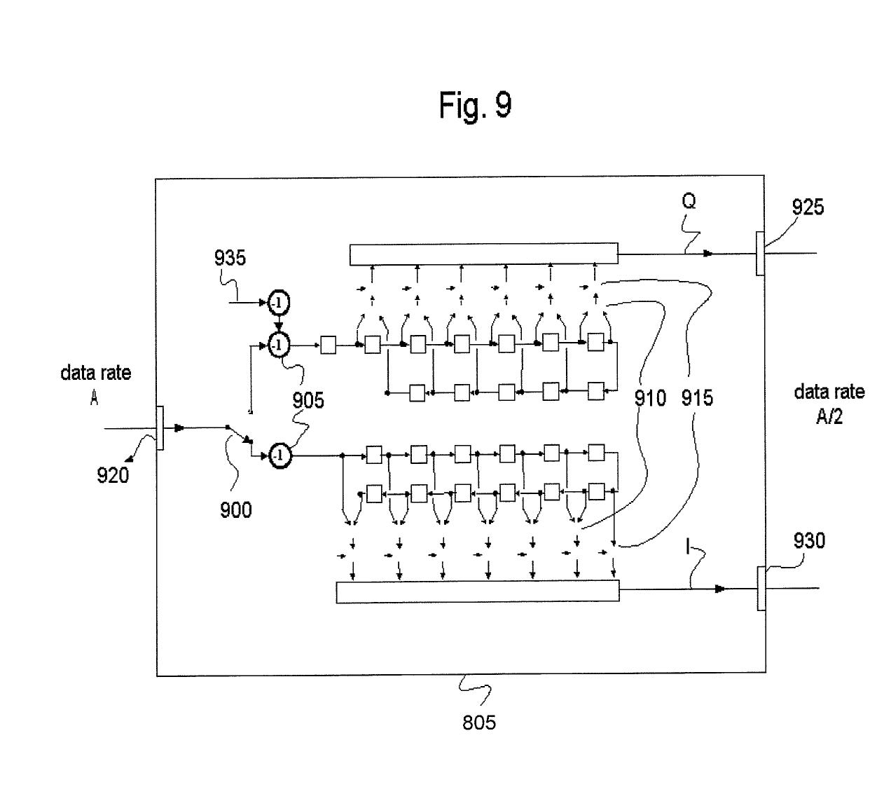

The measurement receiver 235 can be implemented in many different ways. An example of a symmetrical I/Q separation unit 805, which, apart from separating the imaginary and real components of the input signal, also downconverts the signal to half the data rate of the input signal, is illustrated in FIG. 9. The I/Q separation unit 805 of FIG. 9 comprises a demultiplexer 900, sign inverters 905, adders 910, multipliers 915, a signal input 920, an imaginary signal output 925 and a real signal output 930, and can advantageously be used when the sampling rate of the ADC 800 is precisely four times the carrier frequency of the samples signal.

The transmitter output signal 247 can be regarded as the sum of a sine and a cosine wave, which are amplitude modulated with the imaginary (I) and real (Q) parts of transmitter output signal 247, respectively. When the signal is sampled at a rate equal to four times the carrier frequency, every other sample can be sampled when the cosine passes zero, so that only the sine wave contributes to the sample value, and vice versa. Thus, a sampling rate of 4*f₀ yields every fourth sample to be a positive imaginary sample, every fourth sample to be a positive real sample, every fourth to be a negative imaginary sample and every fourth to be a negative real sample. Thus, the I/Q-separation unit 805 can advantageously be implemented using a demultiplexer 900, the demultiplexer 900 alternating between two different outputs: one output 925 for the imaginary component and one output 930 for the real component of the I/Q converted signal. By, in inverters 905, changing the sign of every other sample fed from the two outputs of the de-multiplexer 900, a sample rate which is half the data rate of the input signal is obtained.

Since the spectrum of the signal received by ADC 800 is not known, the signal obtained by changing the sign of every other sample may or may not be reversed. In order to control whether the sampled signal is reversed or not, an external binary signal 935, which could be generated by e.g. DSP 400, may be used. Furthermore, since the real samples and the imaginary samples obtained by using the above described method are not simultaneously sampled, either the imaginary signal or the real signal output from the I/Q-separation unit 805 should preferably be delayed by one half sample. This can be accomplished by e.g. a FIR-interpolator.

In one embodiment of the invention in which transmitter 215 part of a radio base station 110 in a mobile network 100 operating according to the WCDMA standard, the input signal 205 to transmitter 215 is of data rate 3.84 MHz (referred to as chiprate), the increase in data rate performed by the first up-sampling filter 415 is 8 times chiprate, and the increase in data rate performed by the second up-sampling filter 425 is 2 times chiprate. Hence, in this embodiment, the data rate of signal 435 is 3.84 MHz, the data rate of signal 440 and 445 is 30.72 MHz, and the data rate of signals 450 and 455 is 61.44 MHz, which is the data rate of the radio signal 225 on radio interface 105.

If the first up-sampled signal 440 is used as the reference signal 409 in the analysis of feedback signal 255 in this embodiment, the desired data rate of the feedback signal 255 is hence 30.72 MHz. Thus, in order to utilize the I/Q converter 805 of FIG. 9, the sampling rate of ADC 800 needs to be 61.44 MHz, and the carrier frequency of signal input to the ADC 800 needs to be 15.36 MHz. In order to obtain this, measurement receiver 235 could comprise an analogue part 815 for converting the centre frequency of transmitter output signal 247 down the desired frequency. However, if another implementation of I/Q-separation unit 805 and down converter 810 is used, the analogue part 815 of measurement receiver 235 can be omitted.

Obviously, other ways of performing the down conversion and I/Q-separation may be used than the I/Q-separation unit 805 shown in FIG. 9. A separate I/Q-separation unit 805 and down converter 810 may be used, or the I/Q-separation unit of FIG. 9 may be used in combination with one or many separate down converters 810, if further down conversion is required. If a separate I/Q-separation unit 805 is used, then the ADC 800 could sample the signal at any sampling rate.

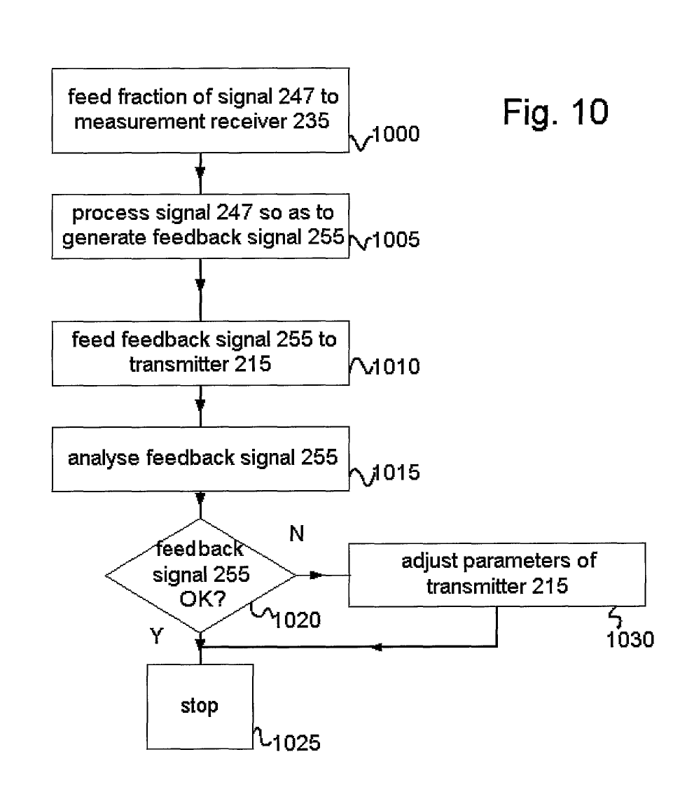

A general illustration of the inventive method is provided in FIG. 10. In step 1000, the transmitter output signal 247 is fed to the antenna 220, and a fraction of the transmitter output signal 247 is fed to the input 240 of measurement receiver 235. In step 1005, the transmitter output signal 247 is processed in measurement receiver 235 so as to generate the feedback signal 255. This processing could advantageously involve analogue-to-digital conversion, I/Q-separation and down conversion, as has been described above in relation to FIGS. 8 and 9. In step 1010, the feedback signal 255 is fed to transmitter 215 via control signal input 250. In step 1015, the feedback signal 255 is analysed by the transmitter 215. This analysis can advantageously be performed as a comparative analysis of properties of a reference signal 409 and the corresponding properties of feedback signal 255. In step 1020, it is checked whether the analysis performed in step 1015 indicates that the feedback signal 255 has desired properties. If so, step 1025 is entered, in which the process is stopped. However, if in step 1020 it is found that the feedback signal 255 does not have desired properties, step 1030 is advantageously entered, in which parameters of transmitter 215 are adjusted so as to compensate for the undesired properties of the feedback signal 255.

In the embodiment of transmitter 215 illustrated in 4, steps 1015-1030 could preferably be performed by the DSP 400. The parameters that are adjusted in step 1030 could preferably be adjustable parameters of digital filters implemented in FPGA 405, such as the adjustable parameters of pre-distortion filter 420 and/or of frequency compensation filter 430, as described in relation to FIGS. 5 and 6. Hence, when in step 1020 the DSP 400 finds that parameters of the digital filters in FPGA 405 should be adjusted, DSP 400 sends, in step 1030, new, updated, parameter values to FPGA 405 via control signal 408.

The processes described in relation to FIG. 10 can be an ongoing process, so that step 1025 is replaced by step 1000, and/or so that several processes as described in FIG. 10 are run in parallel. Alternatively, the process described in FIG. 10 can be performed on request, or at predetermined intervals.

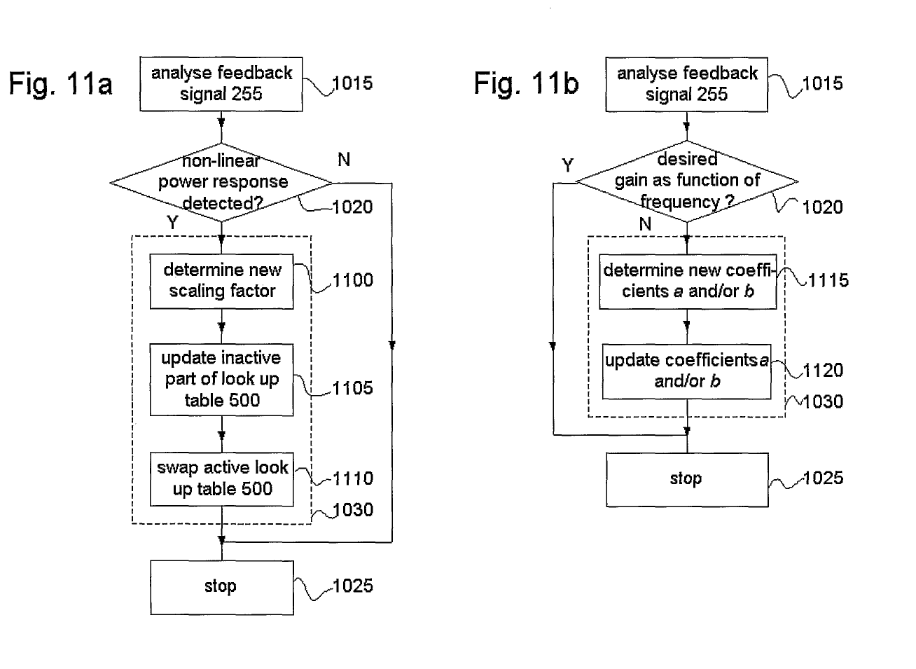

In FIG. 11, step 1030 is described in more detail for the two implementations of the invention discussed in relation to FIGS. 5 and 6. Steps 1100, 1105 and 1110 of FIG. 11a, and steps 1115 and 1120 of FIG. 11b, respectively correspond to step 1030 of FIG. 10. The methods illustrated by FIGS. 11a and 11b could advantageously be combined, and both methods be applied in the operation of a transmitter 215.

FIG. 11a relates to an embodiment of the invention in which a pre-distortion filter 420 is implemented as having a look-up table 500 comprising up-dateable contents. In step 1015 of FIG. 11a, the feedback signal 255 received from the measurement receiver 235 is analysed in relation to a reference signal 409, in order to detect any non-linear power response of analogue circuitry 310 that has not been compensated for by pre-distortion filter 420. In step 1020, it is checked whether any non-linear power response that has not been compensated for has been detected in step 1015. If not, step 1025 is entered, in which the process is stopped. However, if any non-linear power response is detected, then step 1100 is entered, in which new relevant parameters, such as e.g. complex scaling factors, are determined based on the analysis result obtained in step 1015. Step 1105 is then entered, in which the contents of the inactive look up table 500 are updated with the parameters determined in step 1100. In step 1110, the previously inactive, updated, part of look up table is made active, while the previously active part of look up table 500 is made inactive. Step 1025 is then entered.

In step 1015 of FIG. 11b, the amplitude of the feedback signal 255 received from the measurement receiver 235 is analysed in relation to the amplitude of the reference signal 409, in order to determine the gain of the transmitter 215. In step 1020, it is checked whether the gain is acceptable: Does the gain of analogue circuitry 310 have an acceptable frequency dependence, and is the power gain of the transmitter 215, i.e. the power gain of analogue radio circuitry 310 and the power gain of digital gain control provided by multiplier 630, if applicable, acceptable? If so, step 925 is entered, in which the process is stopped. If not, however, step 1115 is entered, in which new value of coefficients a and/or b are determined. Step 1120 is then entered, in which the coefficients a and/or b are updated, preferably by sending a control signal 409 indicative of the new value of coefficients a and/or b to the part of transmitter 215 in which the values of the coefficients a and b are stored (preferably in the FPGA 405, if applicable). If both a and b are to be updated, the new values of a and b could obviously be sent in two different control signals 409. Step 925 is then entered, in which the process is stopped.

In the preceding description, for purposes of illustration only, the transmitter 215 and the measurement receiver 235 have been described as two logically separated units. However, the transmitter 215 and measurement receiver 235 could obviously be implemented as the same physical unit, or as separate physical units.

Although in the above discussion, the inventive method and apparatus have been discussed in terms of radio base stations, the invention is applicable to any radio transceiver, such as a radio transceiver in a mobile station, or in any other apparatus sending radio signals.

One skilled in the art will appreciate that the present invention is not limited to the embodiments disclosed in the accompanying drawings and the foregoing detailed description, which are presented for purposes of illustration only, but it can be implemented in a number of different ways, and it is defined by the following claims.

1. A radio transmitter for transmitting a radio signal, said radio transmitter comprising
an transmitter input for receiving a digital signal;
analogue radio circuitry comprising an analogue gain control device;
a transmitter output coupled to an antenna for outputting an transmitter output signal;
at least one digital filter having at least one adjustable parameter, comprising a digital gain control device;
a control signal input for receiving a feedback signal indicative of said output signal; and
programmable digital circuitry adapted to analyze the gain of said feedback signal and to generate a gain analysis result, wherein said programmable digital circuitry is further adapted to adjust the gain of the digital gain control device and the gain of the analogue gain control device in accordance with the gain analysis result.

2. The radio transmitter of claim 1, wherein the analog gain control is a step attenuator, further comprising
means for introducing an offset in the feedback signal upon adjusting the gain control in the step attenuator, which offset acts in the opposite direction of the applied gain adjustment and corresponds to half of an expected gain change caused by the adjustment of the step attenuator.

3. The radio transmitter of claim 2, wherein the means for introducing an offset is the programmable digital circuitry.

4. The radio transmitter of claim 2, wherein the means for introducing an offset is a measurement receiver connected to relay the feedback signal from the transmitter output to the control signal input.

5. The radio transmitter of claim 2, comprising
means for measuring gain variation corresponding to each step change in the step attenuator,
means for storing the measured gain variation in the digital programmable circuitry, and
means for selecting an appropriate offset to be introduced to feedback signal.

6. The radio transmitter of claim 1, wherein
said radio transmitter further comprises a pulse shaping filter, and wherein
said programmable digital circuitry is adapted to using a signal indicative of the output signal from said pulse shaping filter as a reference signal in analyzing the feedback signal.

7. The radio transmitter of claim 1, the radio transmitter further comprising
a pre-distortion filter having adjustable parameters; and wherein said programmable digital circuitry is adapted to adjusting the adjustable parameters of the pre-distortion filter.

8. The radio transmitter of claim 1, wherein
said pre-distortion filter comprises a look-up table having updateable contents; and
said programmable digital circuitry is adapted to updating said contents in accordance with said analysis result.

9. The radio transmitter of claim 1, wherein said look up table comprises an active part and an inactive part, and wherein
said programmable digital circuitry is adapted to updating the contents of said inactive part in accordance with the analysis result, and further adapted to inactivating the previously active part and activating the previously inactive part of the look up table upon having finished the updating of the contents of said inactive part.

10. The radio transmitter of any claim 1, wherein
said at least one digital filter comprises a frequency compensation filter having at least one coefficient (a, b); wherein said programmable digital circuitry is adapted to adjusting said at least one coefficient.

11. The radio transmitter of claim 1, wherein
the analogue radio circuitry comprises an output filter which is a fullband output filter.

12. The radio transmitter of claim 1, further comprising a measurement receiver, the measurement receiver comprising
a measurement input coupled to said transmitter output;
an analogue to digital converter; and
a feedback signal output coupled to said control signal input.

13. The radio transmitter of claim 12, wherein said measurement receiver further comprises
a mixer for mixing an input signal to complex baseband;
an I/Q-separation unit arranged to separate the real and imaginary parts of an input signal; and
a downsampling filter arranged to downsample the signal to a data rate lower than the data rate of the output signal from the analogue to digital converter.

14. The radio transmitter of claim 12, wherein
the analogue to digital converter is arranged to sample the input signal to the analogue to digital converter at four times the carrier frequency of the input signal to the analogue to digital converter; and
a demultiplexer for demultiplexing the sampled signal into one signal representing the imaginary part and another signal representing the real part of the input signal to the analogue to digital converter.

15. A radio base station comprising a radio transmitter for transmitting a radio signal, said radio transmitter comprising
an transmitter input for receiving a digital signal;
analogue radio circuitry comprising an analogue gain control device
a transmitter output coupled to an antenna for outputting an transmitter output signal;
at least one digital filter having at least one adjustable parameter, comprising a digital gain control device;
a control signal input for receiving a feedback signal indicative of said output signal; and
programmable digital circuitry adapted to analyze the gain of said feedback signal and to generate a gain analysis result, wherein said programmable digital circuitry is further adapted to adjust the gain of the digital gain control device and the gain of the analogue gain control device in accordance with the gain analysis result.

16. A method of operating a radio transmitter, the method comprising
receiving a digital signal to be transmitted by the radio transmitter;
processing said digital signal in at least one digital filter having at least one adjustable parameter, comprising a digital gain control device;
converting said processed digital signal into an analogue signal;
processing said analogue signal in analogue radio circuitry of the radio transmitter, comprising an analogue gain control device, thus generating a transmitter output signal;
feeding a signal indicative of the transmitter output signal back to a control part of the radio transmitter as a feedback signal;
analysing the gain of said feedback signal in order to identify correctable deviations from a desired signal; and
adjusting at least the gain of the digital gain control device and the gain of the analogue gain control device so as to minimise identified correctable deviations.

17. The method of claim 16, comprising the step of
introducing an offset in the feedback signal upon adjusting the gain control in the step attenuator, which offset acts in the opposite direction of the applied gain adjustment and corresponds to half of an expected gain change caused by the adjustment of the step attenuator.

18. The method of claim 17, wherein the offset is introduced in a programmable digital circuitry.

19. The method of claim 17, wherein the offset is introduced in a measurement receiver connected to relay the feedback signal from the transmitter output to the control part.

20. The method of claim 17, comprising the steps of
measuring gain variation corresponding to each step change in the step attenuator,
storing the measured gain variation, and
selecting an appropriate stored offset to be introduced to feedback signal.

21. The method of claim 16, wherein
said method further comprises the step of processing said digital signal in a pulse shaping filter; and
the step of analysing comprises comparing said feedback signal to a reference signal, said reference signal being a signal indicative of the output of the pulse shaping filter.

22. The method of claim 16, wherein
said at least one digital filter comprises a pre-distortion filter; and
said adjusting at least one parameter comprises updating parameters of said pre-distortion filter.

23. The method of claim 16, wherein
said pre-distortion filter comprises a look up table, and
said adjusting at least one parameter comprises updating the contents of said look up table.

24. The method of claim 16, wherein
said look up table is implemented as a look up table having at least an active part and an inactive part; and
said updating the contents of said look up table comprises:
updating the inactive look up table; and
activating the previously inactive loop up table, and deactivating the previously active look up table.

25. The method of claim 16, wherein
said at least one digital filter comprises a frequency compensation filter (430) having at least one coefficient (a,b); and
said adjusting at least one parameter comprises adjusting at least one of said at least one coefficients.

26. The method of claim 16, wherein
the step of feeding further comprises sampling the transmitter output signal or a second signal indicative thereof at a rate of four times the carrier frequency of the sampled signal; and
separating the transmitter output signal into an imaginary and a real part by demultiplexing the sampled signal resulting from said sampling.
